(19) United States
(12) Patent Application Publication
(10) Pub. No.: US 2014/0330548 A1
(43) Pub. Date: Nov. 6, 2014

(54) METHOD AND SYSTEM FOR SIMULATION OF ONLINE SOCIAL NETWORK

(71) Applicant: INTERNATIONAL BUSINESS MACHINES CORPORATION, Armonk, NY (US)

(72) Inventors: Ana Paula APPEL, SaoPaulo (BR); Maira Athanazio De Cerqueira Gatti, Sao Paulo (BR); Samuel Martins Barbosa Neto, Sao Paulo (BR); Claudio Santos Pinhanez, Sao Paulo (BR); Cicero Nogueira Dos Santos, Sao Paulo (BR)

(73) Assignee: International Business Machines Corporation, Armonk, NY (US)

(21) Appl. No.: 13/887,354

(22) Filed: May 5, 2013

(51) Int. Cl. G06F 17/50

(52) U.S. Cl. CPC G06F 17/5009
USPC 703/6

(57) ABSTRACT

A method of simulating an online social network (OSN) includes modeling behavior data of a user, the behavior data including sampled real data, and simulating a behavior of the OSN using the modeled data.

### BACKGROUND OF THE INVENTION

1. Field of the Invention

The present invention generally relates to a method and apparatus for simulation of an online social network.

2. Description of the Related Art

Online social networks (OSNs) have recently reached extreme levels of popularity. Thus, data, patterns and information from various OSNs is becoming increasingly valuable.

Information diffusion is a key area to observe. Information diffusion may entail, for example, a process in which a new idea or action widely spreads through communication channels. Today, OSNs are the most used avenues for information diffusion. This area is widely studied by sociologists, marketers and epidemiologists, among others.

Large OSNs provide a useful way for studying information diffusion as topic propagation. It is important for many reasons to understand how users behave when they connect to these OSNs. For example, in the arena of viral marketing, one might wish to exploit models of user interaction to spread certain content or promotions widely and quickly.

Conventionally, there are numerous models of influence spread about in OSNs that attempt to model the process of adoption of an idea or a product. However, it still remains difficult to measure and predict how a market campaign will spread across an OSN if a user or a set of users make a post, forward or reply to a message, or if the user or users does not post at all for a period of time and/or about a particular topic. Further, this difficulty is also present.

An Agent-Based Simulation (ABS), for example, can provide a modeling paradigm that allows the performance of a what-if analysis to attempt to measure and predict how a market campaign will spread across an OSN, for example, as described above.

Conventional approaches may apply ABS to an OSN. However, conventional approaches do not apply ABS to information diffusion in large OSNs. Conventional methodology can be thought of as being of at least two different types.

A first type deals with static techniques. For example, taking at least one snapshot of an OSN and then using the snapshot to perform some sort of analytics. Static model approaches are mainly based on building weighted social networks as graphs and analyzing topologies and features like betweenness centrality.

These and related techniques, however, do not simulate user interactions. Other conventional techniques may attempt to simulate user behavior. Such simulation techniques, however, do not use real data in the simulation and further do not learn from any real data. Indeed, some conventional approaches deal with synthetic networks for deriving an agent's behavior, thus leading to the problem of not being very realistic. At the same time there are some approaches to learn the user behavior in social networks from real data. However, since the goal is not simulation, but only analysis, these behaviors models are limited and cannot be reused as an input to a simulation model.

Thus, there is a need to be able to predict human behavior like posting, forwarding or replying to a message with regard to topics and sentiments within an OSN, and to analyze the emergent behavior of such actions.

Cascade models have received a lot of attention in OSN modeling literature. Some cascade models give a formal exposition of influence (i.e. individuals are nodes in a social network and a directed edge indicates that one node influences another). Depending on the graph configurations, it is more likely that an innovation will be widely adopted.

The disadvantage of this approach is that there will be a graph configuration for each cascade model and the edges represent influence, rather than general social relationship that might spread influence or not. Hence general models cannot be learned and evolved, and are thus limited. The leverage of multiple influence mechanisms and relations for propagating information throughout social networks can be found in the art.

### SUMMARY OF THE INVENTION

In view of the foregoing and other exemplary problems, drawbacks, and disadvantages of the conventional methods and structures, an exemplary feature of the present invention is to provide a method, system and program for simulating an OSN.

In a first exemplary aspect of the present invention, a method of simulating an online social network (OSN) includes modeling behavior data of a user, the behavior data including sampled real data, and simulating behavior of the OSN using the modeled data.

Another exemplary aspect of the present invention includes a non-transitory computer-readable storage medium tangibility embodying a program of machine-readable instructions executable by a digital processing apparatus to perform a method of simulating an online social network (OSN). The method including modeling behavior data of a user, the behavior data including sampled real data, and simulating behavior of the OSN using the modeled data.

Yet another exemplary aspect of the present invention includes a computer program product for simulating an online social network (OSN), the computer program product including a computer readable storage medium having computer readable program code embodied therewith, the computer readable program code including computer readable program code configured to perform a method of simulating an online social network (OSN). The method including modeling behavior data of a user, the behavior data including sampled real data, and simulating behavior of the OSN using the modeled data

Still another exemplary aspect of the present invention includes a method for simulating an online social network (OSN), the method including modeling a microscopic behavior of one or more users in the OSN, simulating a macroscopic behavior of the OSN. The modeling is based on sampled real data and the simulating is based on the modeling.

Yet another exemplary aspect of the present invention includes a system for simulating an online social network (OSN), the system including a modeler for modeling sampled real data and a simulator for simulating an OSN based on the modeled data.

Thus, an exemplary aspect of the present invention can be useful for estimating the value of a large egocentric follower network in a social media platform.

One can also modify a set of users' behavior by changing some probabilities or adding/removing observed actions that the user did or did not perform and then comparing the outcome in the simulator in the observed data.

Further, one can easily evolve the user model from the real data in case of any new action to be observed or removed from the real social media network. Examples of such action include, but are not limited to: liking a post, sending a video/image, etc.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an environment in which methods and systems according to exemplary embodiments of the present invention may be implemented.

FIG. 2 illustrates an exemplary configuration of a one-user state machine.

FIG. 3 illustrates an environment of an OSN according to an exemplary embodiment of the present invention.

FIG. 4 illustrates a multi-agent stochastic simulation according to an exemplary embodiment of the present invention.

FIG. 5A is a chart plotting a volume of messages per time step from two exemplary simulations and a volume of a real OSN.

FIG. 5B illustrates an exemplary validation metric from an exemplary simulation.

FIG. 6A is a chart according to an exemplary validation metric for a “fixed” scenario.

FIG. 6B is a chart according to an exemplary validation metric for a “short night” scenario.

FIG. 7A is a graph of exemplary simulation results plotting analysis for a total number of messages for all topics.

FIG. 7B is a graph of exemplary simulation results plotting analysis for a single topic.

FIG. 8 is a chart of simulation step durations according to an exemplary simulation.

FIG. 9 is a typical hardware configuration 900 which may be used for implementing the inventive aspects of the present disclosure; and

FIG. 10 is a description of exemplary storage media which may be used in conjunction with the typical hardware configuration 900 of FIG. 9 and also with various embodiments of the present invention.

### DETAILED DESCRIPTION OF EXEMPLARY EMBODIMENTS OF THE INVENTION

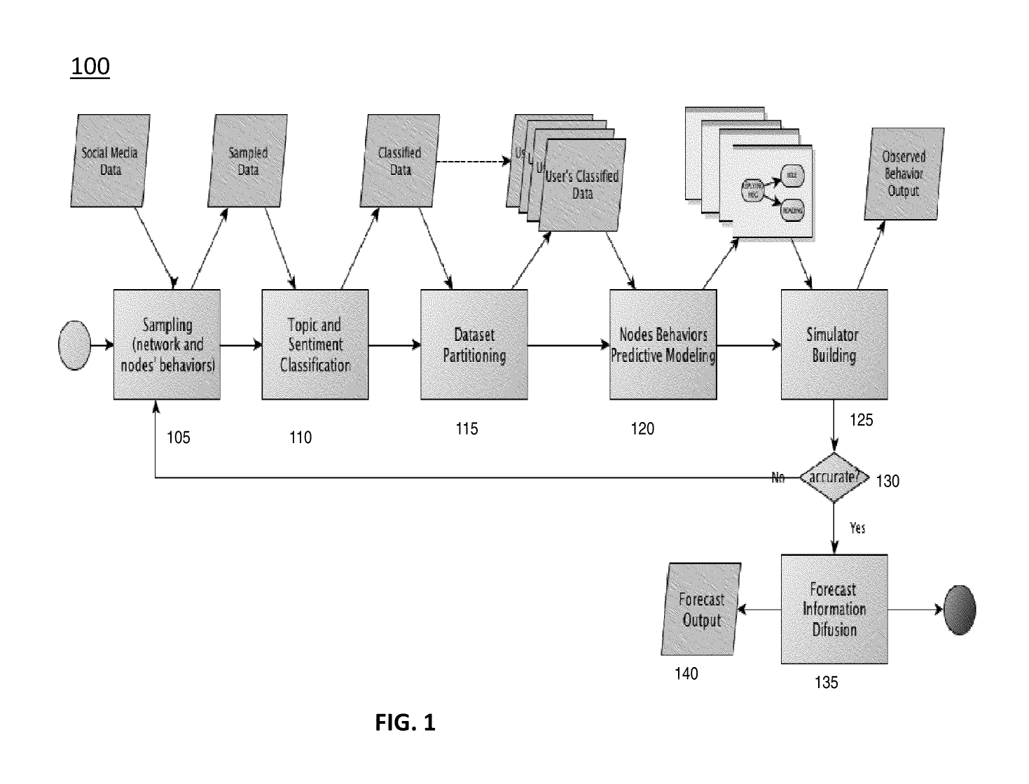

Referring now to the drawings, and more particularly to FIGS. 1-10, there are shown exemplary embodiments of the method and structures according to the present invention.

In an exemplary embodiment, the present invention uses a multi-agent simulation to predict the behavior of social (media) networks. In the simulation, each user (node in a network) is represented by an agent. The simulation has the duration of n steps. At each step, every agent (user) performs an action. The behavior of each agent is modeled, for example, as a state machine where states correspond to possible user actions.

During the modeling phase, historical user activity data (e.g. messages exchanged in the network) can be used to estimate a probabilistic transition function. Historical user activity data is not limited to any specific type of data and may generally include any user data that can be sampled or otherwise obtained.

An exemplary method and system according to an exemplary embodiment of the present invention may be based on a stochastic multi-agent based approach where each agent is modeled from the historical data of each user in the network as a Markov Chain process and a Monte Carlo simulation. The method and system (which may generally be referred to as an approach or a methodology) have at least six phases and is iterative as illustrated in FIG. 1.

The first phase 105 includes sampling the OSN. After cleaning the data, the second phase 110 includes performing topic and sentiment classification on the posts extracted from the sampled data. Then, in phase three (115), from the previously classified data, sets of samples are created for each user.

Each set contains the user's posts and the posts of whom he/she follows. Then, each user behavior model is built (fourth phase 120) from these sets and the models are used as input for the stochastic simulator (fifth phase 125). The models are validated by running the simulation and applying the validation method. This cycle was performed several times by the present inventors until the above exemplary modeling was found.

Once the model is accurate enough, a forecast on information diffusion (130) can be performed. The phases are described in greater detail below (except the Dataset Partitioning phase which is quite straightforward).

A more detailed description of the various exemplary phases mentioned above is herein presented.

### Sampling

The sampling phase 105 can be a starting point of exemplary approaches according to exemplary embodiments of the present invention. The sampling phase 105 may include crawling real data from an OSN. The crawling process can extract both network and user actions.

There are several network sampling methods which include but are not limited to: node sampling, link sampling, and snowball sampling. In node or edge sampling, a fraction of nodes or edges is selected randomly. On the other hand, snowball sampling randomly selects one seed node and performs a breadth-first search (hence the name, snowball sampling), until the number of selected nodes reaches the desired sampling ratio.

Only those links between selected nodes are included in the final sample network. The snowball sampling method is more feasible than node and edge sampling to crawl the OSN, since it is difficult to have access to node and edge randomly and also they have a high probability to produce a network with isolated clusters.

The sampling phase 105 may be performed according to various methods including, but not limited to the examples above. Depending on the particular OSN, the crawling method may vary due to constraints on the Application Programming Interface (API) or OSN policies.

### Topic and Sentiment Classification

Various text mining strategies may be used to perform two important tasks of a modeling approach: topic classification and action sentiment analysis. These may generally be referred to as being inclusive of the second phase 110. The topic classification includes classifying an action as related to a certain topic or campaign (about politics, marketing, etc).

In the sentiment analysis, the objective is to classify an action as a positive or negative sentence. The topic classification task may be performed using a keyword based approach. First, a list of keywords is selected to represent each topic.

Next, each action (i.e., a text of a post) is split into tokens using blank spaces and punctuation marks as separators. In an exemplary classification technique, the tokenized action is discarded or classified as belonging to one of the interesting topics, as follows: If the action (e.g. a post) contains keywords from more than one topic, it is discarded, if the action does not contain any keyword from any topic, it is classified as Other topic. If the action contains at least one keyword from a topic, it is classified as belonging to that topic. There are several techniques for topic classification which may be used, and the present disclosure is not limited to the exemplary discussions above.

The sentiment classification may be performed using a machine learning approach. One can train a Naïve Bayes classifier using, for example, the training data created by a standard approach. In one such approach, the training set may contain examples of positive and negative actions only. Therefore, the learned classifier predicts new actions using these two classes only.

The first step when training or using the classifier is preprocessing. In the preprocessing for the example above, the action is tokenized and at least three strategies are employed to reduce the feature space. Such strategies include, for example, substituting all user names by the word “USERNAME”, substituting all urls (tokens starting with http:) by the word URL and replacing any letter occurring more than two times in a token with two occurrences (e.g. cooooool is converted into cool). In order to train the Naïve Bayes classifier, one may use a feature set composed of token unigrams and bigrams. The final classifier can achieve 82% accuracy when applied to a conventional test set. In general, the topic and/or sentiment classifications may be performed on any action, step, result, etc. within an OSN, and are not limited to anything specific (e.g. liking a post, sharing a video, or image, etc).

### Behaviors Predictive Modeling

In an approach according to an exemplary embodiment of the present invention, the fourth phase 120 includes learning each user's behavior in order to explore the power of interactions. In an OSN, there are numerous actions that can be observed in the data. Such actions include, but are not limited to posting, forwarding, liking or replying a message, for instance. “Liking” can generally be defined as any such positive action related to a post or message, and is not limited to any specific action or any specific OSN. For each action to be modeled, the sampling phase 105 takes into account that the user to be replied or that will have his/her message forwarded must be in the sampled graph.

By way of example, herein is presented a straightforward model that can be learned from the data, where only the posting action is modeled. Hence, such a modeling approach can be used as a foundation to create more complex behavior models, and is not in any way limited to the conditions used for the exemplary approach.

To learn this behavior, a modeler receives the list of users in the OSN as input and, for each user, a document containing his/her posts and the posts of whom he/she follows. From this merged document, the user's state change transitions are modeled as, for example, a Markov Chain, where the current state depends only on the previous state.

Therefore the following assumptions are considered in an exemplary embodiment of the modeler. First, time is discrete and a time interval Δt is considered to define action time windows. Next, user actions are performed in these time windows and states are attached to the user action.

Therefore, a current state on the modeler means what the user posted in the current time window, while a previous state means that the user posted and/or read in the previous time window. Additionally, messages can be interpreted as two vectors: a bit vector which contains bits representing if the topic and sentiment appear in the message, and an integer vector containing the number of messages that appeared in the position where the bit has value 1.

As an example, suppose a user posted a positive message about President Obama, a negative message about some Other topic in the Δt time interval and there are only these two topics and two sentiments (positive and negative) being observed. If the first 2 positions of the vector are for positive and negative Obama index, and the other two for Other in that order; the vector would be [1; 0; 0; 1].

Let R_{t 1} and W_{t 1} be the read and written vector at time t1, respectively, and Wₜ the written vector at time t for a time window Δt, Table 1 describes the transitions and/or states that can be observed in the data and that will be used in the simulator. Empty vectors (R=Φ; or W=Φ;) mean non-observed data.

The Maximum Likelihood Estimation (MLE) with smoothing may be computed to estimate the parameter for each θᵢεΘ transition type. Therefore, for each user's sampled data u we estimate L for observed transitions θ₁, θ₃, θ₅:

$$L ( θ \vert {R}_{t - Δ t} , {W}_{t - Δ t} , {W}_{t} ) = \frac{count ( θ , {R}_{t - Δ t} , {W}_{t - Δ t} , {W}_{t} ) + 1}{count ( {R}_{t - Δ t} , {W}_{t - Δ t} , {W}_{t } ) + \vert S \vert} \qquad ( 1 )$$

and non-observed transitions θ₂, θ₄, θ₆ and θ7:

$$L ( θ \vert {R}_{t - Δ t} , {W}_{t - Δ t} , {W}_{t} ) = \frac{1}{count ( {R}_{t - Δ t} , {W}_{t - Δ t} , {W}_{t } ) + \vert S \vert} , \qquad ( 2 )$$

where |S| is the number of states.

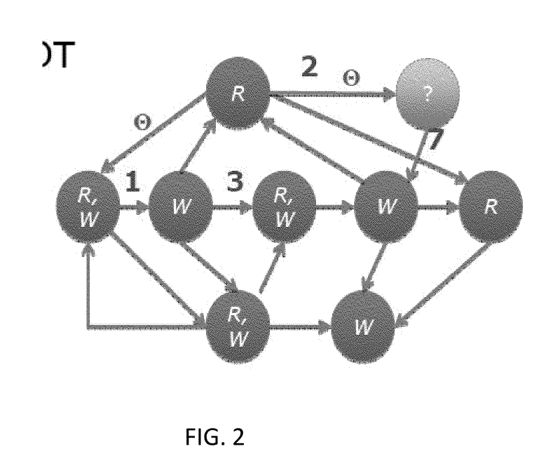

FIG. 2 illustrates a one-user state machine according to an exemplary embodiment of the present invention. A state machine, such as in FIG. 2, can be used to model agent behavior. Each agent (user) is modeled as a state machine whose states are the possible user actions. Usually, social network users can perform many different actions such as to write a message, to post a picture or to post a video. Therefore, it is needed to define the user actions that will be mapped into states in the user behavior model. Examples of possible states (actions) may include, but are not limited to:

Write positive message about topic X;

Write negative message about topic X;

Read positive message about topic X;

Read negative message about topic X; and

Idle (do not perform any action).

Usually, in a simulation, each step simulates a time interval in the real world. For instance, one can define that one step corresponds to 30 minutes of activity in a social network. In this kind of simulation, a state must represent all the user actions in a time interval. Therefore, in a method according to an exemplary embodiment of the present invention, a group of user actions can be mapped into a unique state, which gives more flexibility in the user behavior modeling. Examples of possible states (group of actions) may include, but are not limited to:

Read positive message about topic X AND Write negative message about topic Y; and

Read negative message about topic X AND Read positive message about topic Y AND Write negative message about topic X

To simulate a social network such as, for example, TWITTER or FACEBOOK, the type of information needed to create the states can be extracted using text analytics tools. For instance, a topic classifier and a sentiment analysis tool are enough to generate the information needed to create the example states listed above.

After the definition of agent states, it is desirable to estimate a probabilistic transition function in order to complete the state machine that models the agent (user) behavior. In certain exemplary embodiments of the present invention, for each agent, a method uses historical activity data of one user and the user's neighbors to estimate the probabilistic transition function. In a TWITTER network, for example, all the actions performed by the user's followees may be considered.

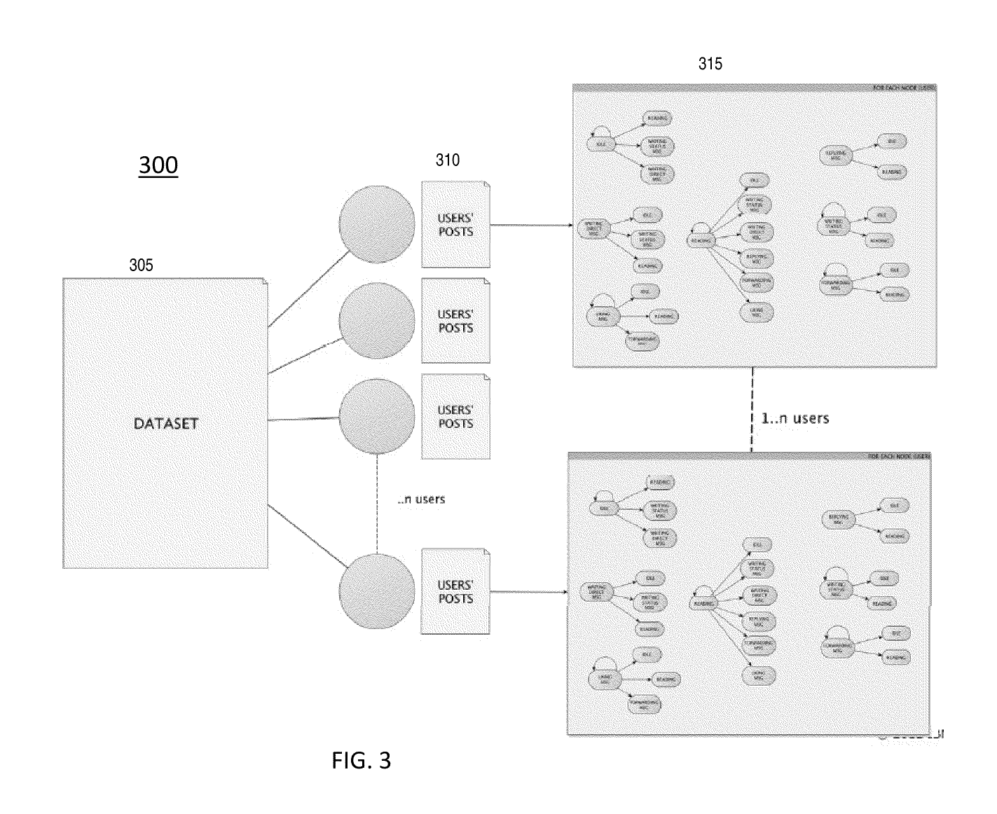

FIG. 3 illustrates an environment 300 of an OSN according to an exemplary embodiment of the present invention. The OSN environment 300 includes a dataset 305 and user posts 310. The OSN environment 300 further includes interaction blocks 315 which show, for each node used, exemplary interactions and exemplary use of historical activity data of a user and the neighbors of the user.

The following exemplary approach may be adopted in certain exemplary embodiments of the present invention. First, a time span corresponding to one single step in the simulation is chosen (e.g. 30 minutes). Next, there is sorting of the user activity data in chronological order. Next, a counter is initialized. Starting from the first activity, the data is traversed sequentially and every time the current activity time minus the time of the first activity in the data is observed, the counter is increased.

Each slice in a state is transformed by summarizing the users' actions. And the transitions (between one state to another) are defined through probabilities of activation based on the counter value. At the end, there is a state machine transitions set for each user where each transition has a probability of being activated learned from the observed data.

The transition probabilities can be, for example, computed as described herein.

Let i be the number of observable actions in the previous state, and j the number of observable/predictable actions in the current state. If an action was not observed in the previous state it has an empty set. The total number T of possible transitions of which we want to learn the probabilities from the data is:

T=2^{i+j}−1,

where we remove the case where all sets are empty, i.e., nothing was observed from the previous state to the current state.

For instance, consider a case where there are only two types of actions that the user can perform: read (R) and write (W) (see, e.g., Table 1, Table 2 and FIG. 2). Given a time window of any size where the past state corresponds to time ‘t−1’ and ‘t’ is the current time, we can observe in the previous state both Rₜ₋₁ and Wₜ₋₁, and we can observe Wₜ in the current state in order to predict it. That would give i=2 and j=1 and T=2³−1=7.

TABLE 1
List of observed states and transitions.
Empty sets represent vectors not observed

| Θ | Transitions |
|---|---|
| 1 | Rₜ₋₁, Wₜ₋₁ ≠ → Wₜ ≠ |
| 2 | Rₜ₋₁, Wₜ₋₁ ≠ → Wₜ = |
| 3 | Rₜ₋₁ = , Wₜ₋₁ ≠ → Wₜ ≠ |
| 4 | Rₜ₋₁ = , Wₜ₋₁ ≠ → Wₜ = |
| 5 | Rₜ₋₁ ≠ , Wₜ₋₁ = → Wₜ ≠ |
| 6 | Rₜ₋₁ ≠ , Wₜ₋₁ = → Wₜ = |
| 7 | Rₜ₋₁ = , Wₜ₋₁ = → Wₜ ≠ |

Further, Table 2 describes the transitions and/or states that can be observed in the data and that will be used in the simulator.

TABLE 2
Description of transitions for two possible
actions: read (R) and write (W).

| Transitions (Θ) | Description |
|---|---|
| 1. R_{t-Δt}, W_{t-Δt} ≠ → Wₜ ≠ | Previous and current state observed |
| 2. R_{t-Δt}, W_{t-Δt} ≠ → Wₜ = | Previous state observed, current state |
| | not observed |
| 3. R_{t-Δt} = , W_{t-Δt} ≠ → Wₜ ≠ | Previous state partially observed |
| | (only W_{t-Δt}), current state observed |
| 4. R_{t-Δt} = , Wₜ₋₁ ≠ → Wₜ = | Previous state partially observed |
| | (only W_{t-Δt}), current state not observed |
| 5. R_{t-Δt} ≠ , W_{t-Δt} = →Wₜ ≠ | Previous state partially observed |
| | (only R_{t-Δt}), current state observed |
| 6. R_{t-Δt} ≠ , Wₜ₋₁ = → Wₜ = | Previous state partially observed |
| | (only R_{t-Δt}), current state not observed |
| 7. R_{t-Δt} = , W_{t-Δt} = →Wₜ ≠ | Previous state not observed, current |
| | state observed |

Also taken into account is that the user may post a message related to a topic and a sentiment, which are grouped and stored in the set Ξ. For this reason, the aforementioned transitions are computed for each topic and sentiment ξᵢεΞ, so that the actions of the users are modeled according to the type of message that he/she is reading or writing.

In considering that the user might behave differently according to the period of the day, a computation is performed of the probability of posting a message at a given period φᵢεΦ, where 1≦i≦K. This takes into account the total of messages mᵢ posted by the user at φᵢ and the messages posted over all periods (the whole day), as in Equation 3. In addition, we consider the following notation for each period φᵢ. The corresponding starting time is denoted φ′ᵢεΦ′, and its length (in hours) is denoted |φᵢ|.

$$L ( posting \vert {φ}_{i} ) = \frac{{m}_{j}}{{\sum }_{{φ}_{j} ∈ Φ}^{ } {m}_{j}} \qquad ( 3 )$$

The volume of messages posted by the user is saved in a vector containing integer values, where each position corresponds to the average number of messages written for an element in the set. Equation 4 describes how to compute the transitions volume, where N represents how many Wt vectors there are for the same θ transition, L denotes the total of topics/sentiments, i.e. |Ξ|, and w₁ⱼ corresponds to the number of messages written for ξₗεΞ and transition θ.

$${V}_{{W}_{t}} ( θ ) = [ \frac{{\sum }_{j ∈ N}^{ } {w}_{ij}}{N} , \frac{{\sum }_{j ∈ N}^{ } {w}_{2 j}}{N} , … , \frac{{\sum }_{j ∈ N}^{ } {w}_{{L}_{j}}}{N} ] \qquad ( 4 )$$

Volume vectors are computed for both transitions and periods. Equation 5 shows how to compute the average for periods:

$$V ( {φ}_{i} ) = [ \frac{{\sum }_{j ∈ M}^{ } {w}_{1 j}^{′}}{M} , \frac{{\sum }_{j ∈ M}^{ } {w}_{2 j}^{′}}{M} , … , \frac{{\sum }_{j ∈ M}^{ } {w}_{{L}_{j}}^{′}}{M} ] , \qquad ( 5 )$$

where M represents how many different vectors there are for period φᵢ, and w′₁ⱼ, corresponds to the number of messages sent for the topic/sentiment ξₗεΞ at a period φᵢ.

The volume vector V (Φᵢ), as will be explained further, is used by the simulator to set different weights to V_{Wt} (θ), according to the current period Φᵢ. For this reason, we divide each position of V (Φᵢ) by the mean observed volume over all periods. As a consequence, the periods where the user posted a larger volume of messages will have greater weights than periods where he/she posted fewer messages. Equation 6 is a demonstration of how this division is done.

$${V}^{′} ( {φ}_{i} ) = [ \frac{{v}_{1 i}}{{\overline{v}}_{1 j} {\vert}_{{φ}_{j} ∈ Φ}} , \frac{{v}_{2 i}}{{\overline{v}}_{2 j} {\vert}_{{φ}_{j} ∈ Φ}} , … , \frac{{v}_{Li}}{{\overline{v}}_{Lj} {\vert}_{{φ}_{j} ∈ Φ}} ] \vert {v}_{li} ∈ V ( {φ}_{i} ) \qquad ( 6 )$$

Where v₁ᵢ denotes the volume for the topic/sentiment 1 and period φᵢ.

Simulation

The discussion now turns to the simulation phase 125. A SMSim simulator herein described according to an exemplary embodiment of the present invention may be, for example, a stochastic agent-based simulator where each agent of the system encapsulates the social media network user behavior and the environment where the agents live and interact is the followers Graph extracted from the social media network. Since each user is an agent in the simulator, the corresponding graph notation is G=(A; R) where A is the set of agents and R is the set of followers relationships.

The SMSim may be modeled as a discrete-event simulation where the operation of the system is represented as a chronological sequence of events.

Each event occurs at an instant in time (which is called a time step or simply just a step) and marks a change of state in the system. The step exists only as a hook on which the execution of events can be hung, ordering the execution of the events relative to each other. The agents and environment are events at the simulation core.

Therefore, the basic agent actions in the simulator are To Read or To Post and the agent states are Idle or Posting and in both states the agent reads the received messages from whom she follows and can write or not depending on the modeled behavior. When the agent is posting a message, at the simulator level, it is sending the message to all its followers.

The message can have a positive or negative sentiment about a topic. Further, sentiment may be measured in degrees such as weak-positive, strong-negative, or even neutral. This is how the messages are propagated during simulation.

The agent behavior may be determined by, for example, a Markov Chain Monte Carlo simulation method. It was previously described how the user behavior is modeled as a Markov Chain which may also hereinafter be referred to as the UserModel structure. During the SMSim initialization two important steps are performed: (i) the graph is loaded from the edges list file, and (ii) for each user in the graph, an agent instance is created and each UserModel file is deserialized into the agent model.

The SMSim may be implemented using Java, for example, but is not limited to such, as any programming language may be used unless context dictates otherwise. The second step is performed by translating the transitions saved in the UserModel by the modeler to a map where the key represents the source state id and the value is another map containing the probabilities to go from the source state id to the target state id, i.e., the key of the latter map is the target state id and the value is the SimTransition which contains the set of probability values.

There maps may be indexed by the state's id to improve performance, since each agent will have a set of transitions and there will be thousands of agents in the system interacting at the same time.

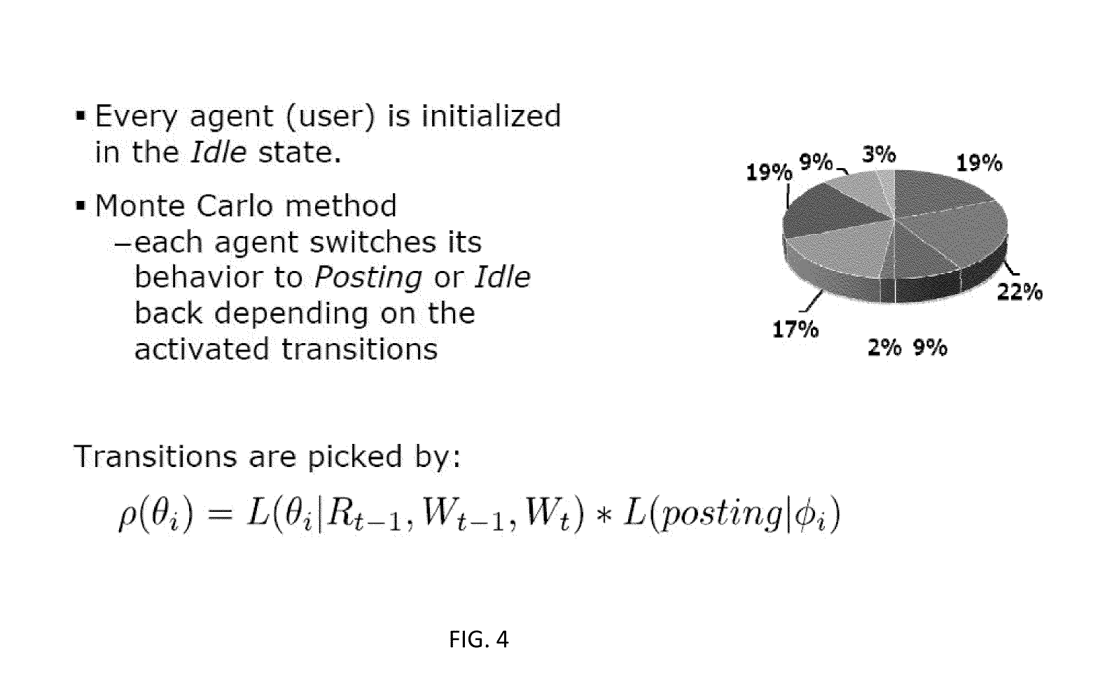

FIG. 4 shows an exemplary multi-agent stochastic simulation graph. Every agent (user) is initialized in the Idle state. When the SMSim is started, each agent switches its behavior to Posting or Idle back depending on the activated transitions using, for example, the exemplary Monte Carlo method. The transition will only be activated if the probability value calculated as described in Equation 7 corresponds to a random value generated by the system, where v_{wt} εV_{Wt}

ρ(θᵢ)=L(θᵢ|Rₜ₋₁,Wₜ₋₁,Wₜ)*L(posting|φᵢ) (7)

In this case, once transition θᵢ is picked, the volume of messages to be posted for each topic and sentiment 1 in the period Φᵢ of current time step is calculated using the weighted value of the corresponding average volume:

ν(θ,φᵢ,ξₗ)=ν_{w}_{ᵢ}(θᵢ)*ν′ₗᵢ(φᵢ) (8)

If no transition is activated, the system switches the user's state to Idle.

The state machines learned for each user can be used as input for all the users in the graph, the graph is loaded and a stochastic agent-based simulator is instantiated. A set of parameters can be specified and the simulation is initialized. Each user (agent) in the multi-agent simulator will stochastically perform an action according to the state machine loaded and on which time step of simulation one transition of each user is activated.

The overall behavior is monitored and observed and the outcome is evaluated through a set of metrics. The same metrics can be applied to any real social media network.

The advantages of this approach are at least twofold. First, one can modify a set of users' behavior by changing some probabilities or adding actions that the user didn't perform and then observe the outcome in the simulator. Next, one can easily evolve the user's model from the real data in case of any new action to be observed or removed from the real social media network (e.g. liking a post, sending a video/image, etc.)

### Validation

A validation 130 can also be performed. In certain exemplary embodiments, the validation may take place until a certain threshold of accuracy is reached or exceeded. Such a validation is illustrated in FIG. 1, as there is a determination of whether an accuracy threshold has been met.

The Root Mean Square Error (RMSE) is frequently used to validate simulation models or to evaluate the differences between two simulation models, and is presented in Equation 9.

$$RMSE ( T ) = \sqrt{\frac{{\sum }_{t = 1}^{T} {( {y}_{t}^{′} - {y}_{t} )}^{2}}{T}} , \qquad ( 9 )$$

where yₜ′ represents the total of messages sent in the simulator at time t, and yₜ denotes the total of messages sent at time t in the observed data.

Such models can be validated using, for example, the Coefficient of Variation of the Root Mean Square Error CV_{RMSE} (Equation 10), where the results of the simulator are compared with those computed from the observed data. Hence RMSE is applied to compare the curve of the total of messages sent by the users in the simulator, up to a time T, with the curve plotted from the observed data used to estimate the parameters of the simulator; and the CV_{RMSE} normalizes to the mean of the observed data. With these metrics both pattern and volume can be compared.

$${CV}_{RMSE} ( T ) = \frac{RMSE ( T )}{\overline{y} {\vert}_{t = 1}^{T}} \qquad ( 10 )$$

### Experimental Results

In this section exemplary results of exemplary experiments carried out by the inventors to evaluate the simulator are presented. A main goal is compare the total number of messages posted by the users in the simulator with the total number of messages sent by the real users. For this task it was considered a dataset consisting of tweets extracted from Barack Obama's TWITTER network, posted during the 2012 United States presidential race.

As a consequence, what was modeled was an egocentric network, centered on Obama, composed of 24,526 nodes. These nodes, along with about 5.6 million tweets, were sampled from the real network using a method earlier. This dataset allows one to model and simulate the behavior of the users in the network when reading and posting messages related to the two main candidates of the 2012 elections: Barack Obama and Mitt Romney.

For this reason, the topics/sentiments in are set to (‘Obama Positive’, ‘Obama Negative’, ‘Romney Positive’, ‘Romney Negative’, ‘Other’), where the two main topics are ‘Obama’ and ‘Romney’ and the two main sentiments are ‘Positive’ and ‘Negative’. Note that ‘Other’ corresponds to a message whose topic is neither Obama nor Romney, and whose sentiment is not relevant in this work.

All tweets were then classified into a topic/sentiment of using the two-step procedure described earlier. In this case, 17,853 tweets were classified as ‘Obama positive’ and 8,766 as ‘Obama negative’. Most of the remaining tweets were considered as ‘Other’. More details about the sampled dataset are presented in Table 3.

TABLE 3
Sampled Data, Topic and Sentiment Classification Results

| | | | | | TS Classification | | |
|---|---|---|---|---|---|---|---|
| Tweets | Active Users | Direct Followers | Edges | Triangles | Other | OB+ | OB− |
| 5.6M | 24,526 | 3,594 (0.017% of real amount) | 160,738 | 83,751 | 5,564,170 | 17,853 | 8,766 |

Next, greater detail about the topic and sentiment classification, the scenarios and results obtained in these experiments, and the performance of the simulator in terms of time is provided.

### Topic and Sentiment Classification

In the exemplary experiment, two topics are considered: Barack Obama and Mitt Romney. The keyword list used for the Obama topic includes the words: barack, barack2012, barackobama, biden, joebiden, josephbiden, mrpresident, obama, obama2012, potus. For Romney, the keywords include: mitt, romney, mittromney, paulryan, governorromney, mitt2012, romney2012. Note that we also considered hashtags (e.g. #obama, #romney, #gobama, #obamabiden2012, #goromney, #romneyryan2012) and usernames (e.g. @BarackObama, @MittRomney, @JoeBiden and @PaulRyanVP).

In addition, besides the cases considered for topic classification described above, we also considered a special treatment for messages originated by Obama. That is, if a tweet is generated by Obama himself, we also consider some personal pronouns (such as I, me, my, mine) and the keyword president to classify the main topic of the tweet as ‘Obama’. According to this rule, retweets of Obama's messages also consider these additional terms. In this case, though, the RT @username text fragment is ignored for topic evaluation to avoid that a retweet of an original negative message is classified as a negative post about the candidate.

### Scenarios and Results

The social network dynamics simulations for the 24,526 users consider two distinct scenarios:

Fixed: Modeler with 4 periods with equal durations: all periods=(‘Night’, ‘Morning’, ‘Afternoon’, ‘Evening’) have the same length of hours, i.e. |φᵢ|=6, ∀φᵢεΦ, with the corresponding starting times defined as Φi″=(12:00 AM, 6:00 AM, 12:00 PM, 6:00 PM).

Short Night: Modeler with 4 periods and short night: the same 4 periods in as the other scenario but the ‘Night’ period is shorter with a duration of 4 hours and starting later, the morning, afternoon and evening are shifted, and afternoon and evening have 1 hr longer duration. The corresponding starting times are defined as Φi″=(4:00 AM, 8:00 AM, 2:00 PM, 9:00 PM).

For both scenarios, Δt=15 minutes. The ‘Short Night’ scenario was defined based on two observations: (i) the time observed in the data is UTC-3, Brasilia, Brazil time, however the majority of users are in the USA. Hence the minimum time zone difference is 3 hours, and (ii) the night period in the observed data is shorter compared to the others periods.

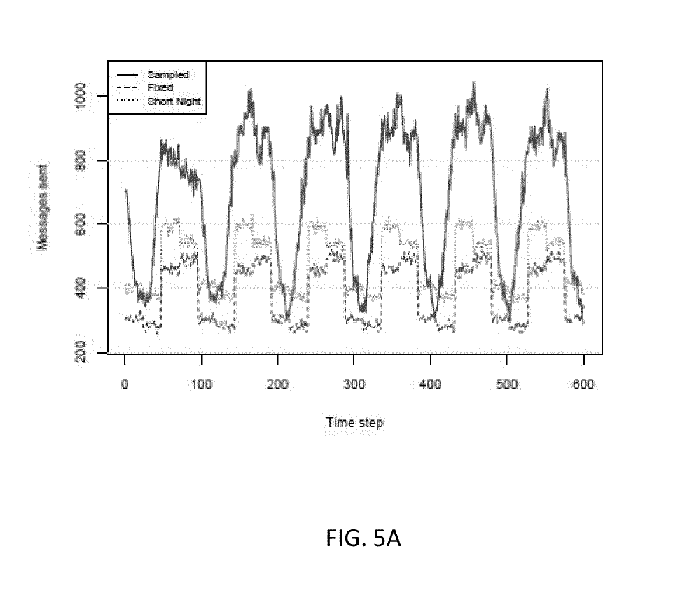

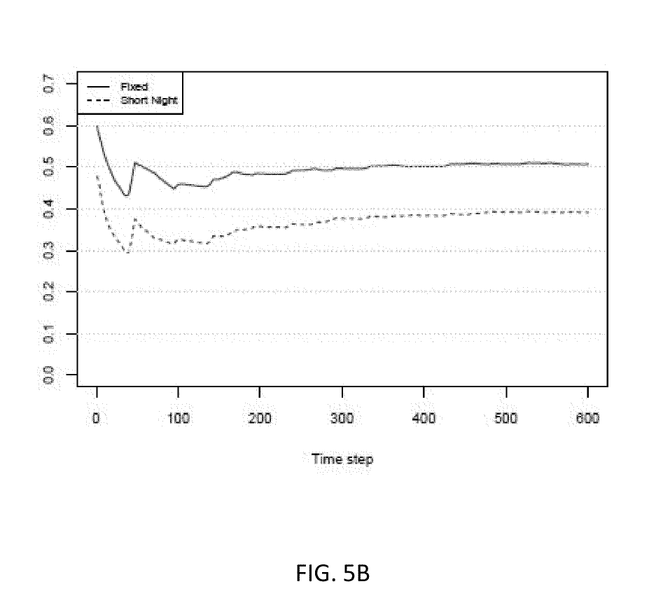

For each scenario, 10 simulation trials were run and the average computed. In FIG. 5A the curves representing the volume of messages sent at each simulation step, for both scenarios, are shown along with the volume of messages plotted from the sampled data. In both scenarios, the volume of messages results in a curve whose shape is similar to that computed from the real data. This shows that the proposed approach is promising towards an accurate modeling of users' behavior in social media networks.

In FIG. 5B the validation with CV_{RMSE} as described above is shown. It can be observed that the error rate of the simulator in the ‘Short Night’ scenario is generally lower than in the ‘Fixed’ scenario. This indicates that the proper setting of the length and the starting times of the periods may improve the overall modeling of the users' behavior.

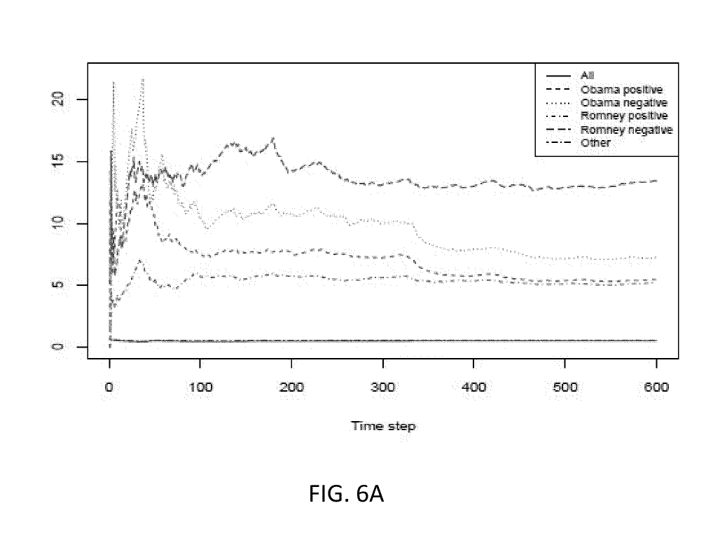

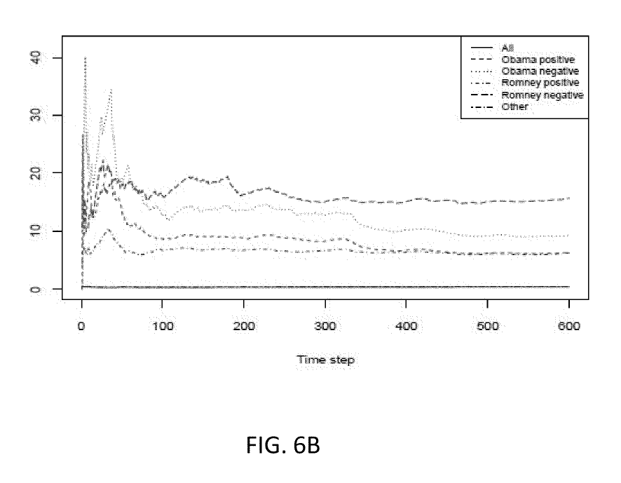

In order to measure the influence around the topics, we discuss the impact on the volume of messages sent through the simulated network by removing important users from it. Because the ‘Short Night’ scenario resulted in a better accuracy, the inventors performed sensitive analysis on the users simulation models estimated with that scenario. The impact can be measured with RMSE and CV_{RMSE}. In FIGS. 6A and 6B CV_{RMSE} results are shown for both the total number of messages for all topics and for the ‘Obama’ topic, respectively.

“Obama off” means that the agent representing Obama's behavior is inactive in the network. ‘Top10 off’ and ‘Top100 off’ mean that the top 10 and top 100 influencers are inactive in the network, respectively. Additionally, ‘Random100 off’ means that 100 users randomly selected are inactive in the network. Recall that Obama is the seed of an egocentric network and his influence impacts more than a set of agents that are not influencers. Additionally, it is beneficial to analyze their impact to test various hypotheses.

Consider hypothesis 1: When the seed of the network is inactive, the influence spread by the seed drops considerably. Also consider hypothesis 2: When the top N most engaged users that are also direct seed's followers are inactive, the influence spread by them drops considerably.

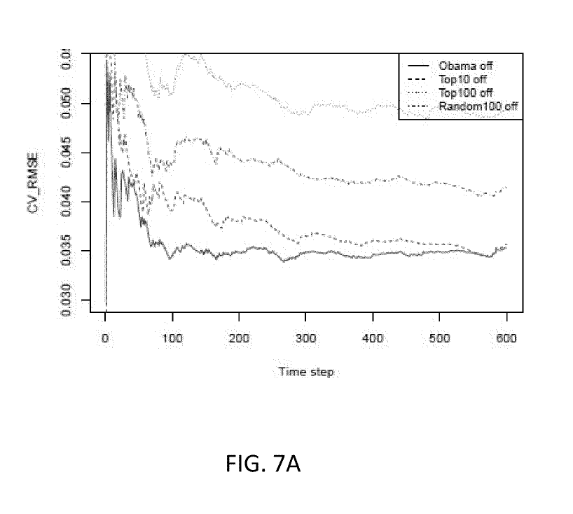

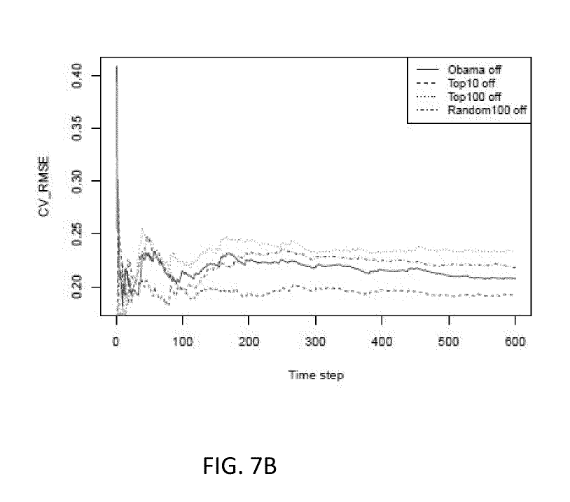

From FIG. 7A a number of observations can be made. First, Obama's influence on the overall number of messages regardless the topic is lower than the inactivation of the others top influencers or inactivation of the random picked users. Further, Obama's overall influence is less than 1 message per time step on average.

On the other hand, in FIG. 7B it is apparent that the impact on the volume of messages about Obama is much higher with an increase of 22% on average. Moreover, Obama has more influence than the top 10 influencers but less than the top 100 influencers and random 100 users, over time. And the Top100 series dominates the others. From these experiments, both hypotheses were observed in the results.

The exemplary experiments above were run in a Red Hat x86 64 Linux with 256 GB memory size and 16 CPU cores. For the sample used, both the modeler and simulator scaled in a linear time. However the inventors tested some scenarios with a complementary sample not used for the previous experiments described. If some users have more than 100 leaders the modeler was highly impacted, while the simulator had a lower increasing in the execution time.

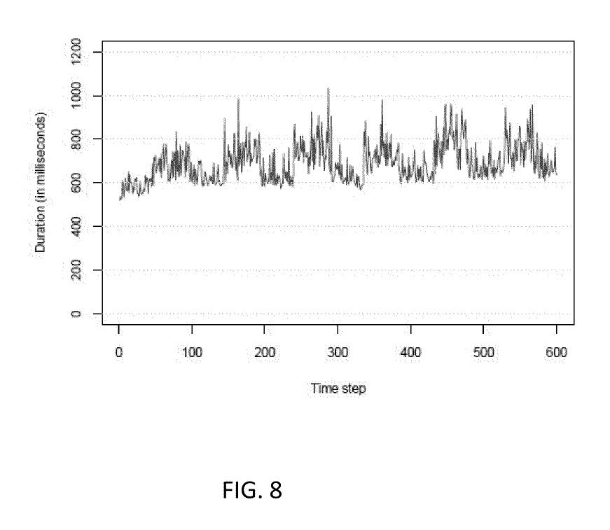

On the other hand the simulator execution time scales with the size of the network. FIG. 8 shows the average simulation steps durations for 10 simulations trial with 602 steps and 24 k agents. It is noted that the conditions described are merely exemplary, and the present disclosure is in no way limited to the above.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

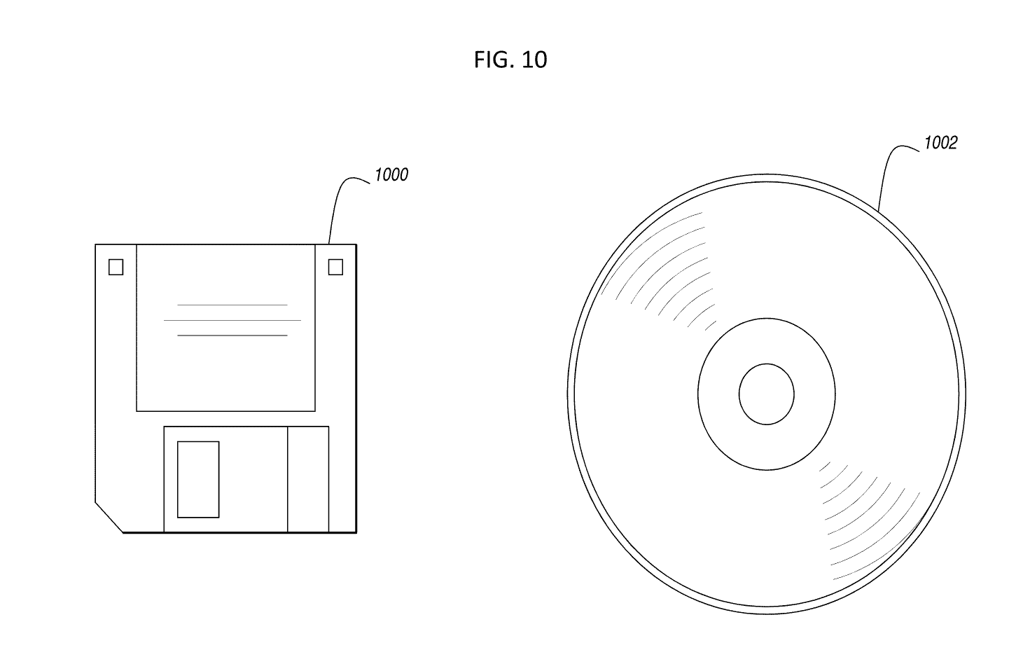

Any combination of one or more computer readable medium(s) may be utilized. The computer readable medium may be a computer readable signal medium or a computer readable storage medium. FIG. 10 shows some exemplary computer readable storage mediums. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or system. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

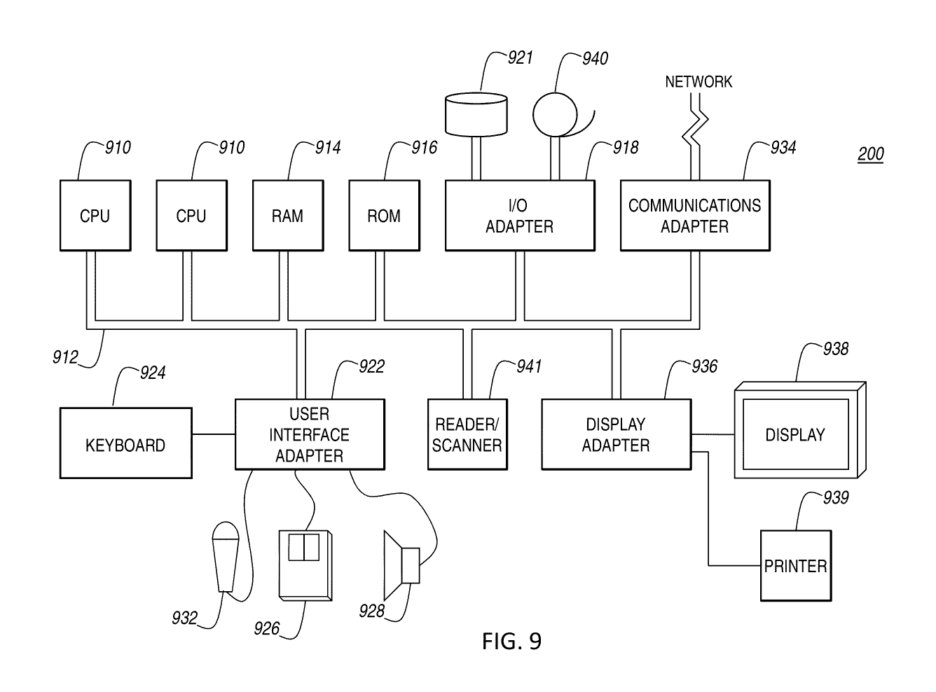

FIG. 9 shows a typical hardware configuration 900, which may be used for implementing the aforementioned inventive aspects of the present disclosure. The configuration has preferably at least one processor or central processing unit (CPU) 910. The CPUs 910 are interconnected via a system bus 912 to a random access memory (RAM) 914, read-only memory (ROM) 916, input/output (I/O) adapter 918 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, an Intranet, a personal area network (PAN), etc., and a display adapter 936 for connecting the bus 912 to a display device 938 and/or printer 939. Further, an automated reader/scanner 941 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of storage media.

Thus, this aspect of the present invention is directed to a programmed product, including storage media tangibly embodying a program of machine-readable instructions executable by a digital data processor to perform the above method.

Such a method may be implemented, for example, by operating the CPU 910 to execute a sequence of machine-readable instructions. These instructions may reside in various types of storage media.

Thus, this aspect of the present invention is directed to a programmed product, including storage media tangibly embodying a program of machine-readable instructions executable by a digital data processor incorporating the CPU 910 and hardware above, to perform the method of the invention.

This non-transitory storage media may include, for example, a RAM contained within the CPU 910, as represented by the fast-access storage for example. Alternatively, the instructions may be contained in another storage media, such as a magnetic data storage diskette 1000 or compact disc 1002 (FIG. 10), directly or indirectly accessible by the CPU 910.

Whether contained in the computer system/CPU 910, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable storage media. In an illustrative embodiment of the invention, the machine-readable instructions may comprise software object code, compiled from a language such as C, C++, etc.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method of simulating an online social network (OSN), said method comprising:
modeling behavior data of a user, said behavior data comprising sampled real data; and
simulating a behavior of the OSN using the modeled data.

2. A non-transitory computer-readable storage medium tangibility embodying a program of machine-readable instructions executable by a digital processing apparatus to perform the method according to claim 1.

3. A computer program product for simulating an online social network (OSN), the computer program product comprising:
a computer-readable storage medium having computer-readable program code embodied therewith, the computer-readable program code comprising:
computer-readable program code configured to perform the method of claim 1.

4. The method according to claim 1, further comprising:
validating the simulated behavior using a validation metric.

5. The method according to claim 4, wherein said validating is performed until an accuracy of said simulated behavior is greater than or equal to a threshold amount.

6. The method according to claim 1, further comprising forecasting an information diffusion.

7. The method according to claim 6, wherein said forecasting comprises computing a probability of posting a message at a given period.

8. The method according to claim 1, wherein said modeling comprises learning a behavior of one or more users.

9. The method according to claim 1, wherein said modeling comprises:
assigning a state to one or more users; and
observing a transition from said state to another state.

10. The method according to claim 9, wherein a current state depends on a previous state.

11. The method according to claim 1, wherein said modeling comprises computing a Maximum Likelihood Estimation (MLE) to estimate a parameter for a transition type.

12. The method according to claim 1, further comprising comparing a simulation result with a result computed from observed data.

13. The method according to claim 1, wherein said modeling comprises calculating a probabilistic transition function using at least one of user historical activity data and user neighbor historical activity data.

14. The method according to claim 1, wherein, in said simulating, a user of the OSN comprises an agent.

15. A method for simulating an online social network (OSN), said method comprising:
modeling a microscopic behavior of one or more users in the OSN; and
simulating a macroscopic behavior of the OSN,
wherein said modeling is based on sampled real data,
wherein said simulating is based on said modeling.

16. A system for simulating an online social network (OSN), the system comprising:
a modeler for modeling sampled real data; and
a simulator for simulating an OSN using the modeled data.

17. The system according to claim 16, wherein said modeler receives a list of users in the OSN.

18. The system according to claim 16, wherein said modeler receives, for a user, information related to the user.

19. The system according to 18, wherein said information related to the user comprises an action including at least one of a user action and a follower action.

20. The system according to 19, wherein the action comprises one or more of posting, forwarding, liking and replying.
